(19) United States
(12) Patent Application Publication
(10) Pub. No.: US 2011/0005097 A1
(43) Pub. Date: Jan. 13, 2011

(54) CLOTHES TREATING APPARATUS AND CONTROLLING METHOD THEREOF

(76) Inventors: Jung Wook Moon, Gyeongsangnam-do (KR); Dae Yun Park, Gyeongsangnam-do (KR); Sog Kie Hong, Gyeongsangnam-do (KR); Jong Seok Kim, Gyeongsangnam-do (KR); Seung Gyu Ryu, Gyeongsangnam-do (KR); Hye Yong Park, Gyeongsangnam-do (KR); Chang Gyu Choi, Gyeongsangnam-do (KR); Dong Won Kim, Gyeongsangnam-do (KR)

Correspondence Address: MCKENNA LONG & ALDRIDGE LLP, 1900 K STREET, NW, WASHINGTON, DC, 20006, US

(21) Appl. No.: 12/309,887

(22) PCT Filed: Aug. 4, 2008
(86) PCT No.: PCT/KR2008/004515

§ 371 Date: Sep. 14, 2010

(30) Foreign Application Priority Data
Aug. 3, 2007 (KR) 10-2007-0078293

(51) Int. Cl. F26B 3/00; F26B 25/06; F26B 21/06

(52) U.S. Cl. 34/493; 34/202; 34/73

(57) ABSTRACT

A clothes-treating apparatus and a controlling method thereof are disclosed. According to a controlling method of a clothes-treating apparatus, a predetermined operational condition of a compressor included in a heat pump to supply dry air to clothes placed therein may be maintained normally. Furthermore, a cooling fan provided in a mechanism compartment is operated only if an internal environment of the mechanism compartment is out of the normal operational condition of the compressor. As a result, noise created from operation of the cooling fan may be reduced and dust that happens to be sucked into the mechanism compartment when external air is drawn may be minimized.

This application is a national stage entry of International Application No. PCT/KR2008/004515, filed on Aug. 4, 2008, and claims the benefit of Korean Application No. 10-2007-0078293, filed on Aug. 3, 2007, both of which are hereby incorporated, in their entireties, by reference for all purposes as if fully set forth herein.

The present invention relates to a clothes-treating apparatus and a controlling method thereof. More particularly, the present invention relates to a control system for a cooling fan that is provided in a mechanism compartment of a clothes-treating apparatus. The cooling fan cools a compressor of a heat pump, where the heat pump is used to supply dry heated air to clothes placed in an accommodating space.

### BACKGROUND ART

When wearing a piece of clothing more than once, without washing between wearing, characteristics such as unwanted odors, wrinkles and/or, humidity, or the like may remain with the clothes. Such characteristics may give an unpleasant feeling to a person who tries to wear the piece of clothing again. To remove the odors or humidity, the piece might be washed, however, quite often rewashing of clothing leads to a shortening of the useful life of the clothing, and may result in costs required to wash the clothes.

In addition, even after washing and drying the clothes, wrinkles may remain. It is inconvenient for the person to perform additional chores like ironing and variations of it, and to not be able to put on the clothes immediately after the washing and drying process is completed. To solve these problems, what is needed is a clothes-treating apparatus that may be used to remove unwanted odors, wrinkles, and/or humidity that remain with the clothes after wearing, but before complete washing.

According to the clothes-treating apparatus, dry air or dry hot air is supplied to the clothes placed in an accommodating space. The clothes may have an unwanted amount of moisture and/or unwanted odors or wrinkles.

According to the above process, unwanted odors, wrinkles, and humidity remaining in or on the clothes may be removed and the user may put on any piece of clothing, even if the clothing was not washed after the previous wearing, with a pleasant feeling.

An air supply device including a heat pump as a drying/heating means may be used during a clothes drying process to supply dry or dry hot air to the clothes. A heat pump is a device that absorbs heat of ambient air in a first space and exhausts the heat to a second space, different from the first. Typically, a heat pump is employed as a heating/cooling means in an air conditioning system and includes an indoor unit and an outdoor unit. When used to heat a space, the heat pump absorbs heat from low temperature outdoor air by evaporating refrigerant in the outdoor unit, and exhausts the heat through condensation of the refrigerant at a heat exchanger provided in the indoor unit.

The heat pump includes a compressor to compress the refrigerant and a heat exchanger to transfer the heat. The heat exchanger dehumidifies damp air inside the clothes-treating apparatus during a process of evaporating refrigerant that is supplied by the compressor. The heat exchanger then re-heats the dehumidified air during a process of condensing the refrigerant.

Turning to FIG. 1, the compressing of the refrigerant may performed by a compressor 22 provided in the mechanism compartment 20 where the heat pump is mounted. The compressor 22 repeats the refrigerant compressing process and as a result, operational conditions of the compressor might reach undesirable levels due to the constant work being performed by the compressor 22. The operational condition of the compressor may be, for example, an environmental variable including temperature or pressure. Certain limits on environmental variables are necessary in order for the compressor to operate normally. If the operational condition is not within predetermined limits, the reliability of refrigerant compression may deteriorate, which typically will result in requiring increased power consumption to operate the compressor.

What is needed is a clothes-treating apparatus and method f controlling the clothes treating apparatus that will alleviate at least some of the problems identified above.

### SUMMARY OF THE INVENTION

To solve the problems, where a heat pump is used to supply dry air or dry hot air to clothes placed in a clothes-treating apparatus, an embodiment of the present invention provides a method to control a cooling fan, provided in the mechanism compartment, to cool the compressor of the heat pump.

In accordance with one aspect of the present invention, the aforementioned may be achieved by a method of controlling a clothes treating apparatus that comprises an air supply device, including a heat pump and a circulation duct, that are provided in a mechanism compartment partitioned or separated from an accommodating space within a cabinet, a moisture generation device, which supplies moisture to the accommodating space, and a cooling fan are described herein. In accordance with one exemplary embodiment, the method may involve operating the heat pump; measuring a parameter associated with the operational condition or a property of a compressor of the heat pump; and controlling the cooling fan provided in the mechanism compartment based on the operational condition of the compressor.

The controlling method may further include supplying moisture to the accommodating space, prior to the measuring one or more parameters that reflect the operational condition of the compressor. The moisture generation device may be a steam generator. Alternatively, the moisture generation device may be a water spraying device capable of supplying a mist or fine water particle dispersion to the accommodating space. It will be understood that more than one type of moisture generation device may be employed.

### BRIEF DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure. In the drawings:

FIG. 1 is a diagram schematically illustrating a conventional clothes-treating apparatus having an accommodating space in which clothes are placed;

FIG. 2 illustrates the main elements inside a conventional mechanism compartment that supplies hot air to the clothes by using a heat pump;

FIG. 3 illustrates a compressor and a cooling fan provided in the mechanism compartment according to an embodiment of the invention; and

FIG. 4 is a block diagram of a controlling method of a clothes-treating apparatus according to an exemplary embodiment of the invention.

### DETAILED DESCRIPTION OF THE INVENTION

Reference will now be made in detail to the specific embodiments of the present invention, examples of which are illustrated in the accompanying drawings. Wherever possible, the same reference numbers will be used throughout the drawings to refer to the same or like parts.

As used herein, a clothes-treating apparatus refers to apparatus that treats clothes placed in a space configured to accommodate clothing in a cabinet of the clothes-treating apparatus (referred to hereinafter as an accommodating space). Here, the term “treat” may encompass any of several predetermined processes, for example, ventilating air through clothes, where the air can be dry and/or heated. Additionally or alternatively, moisture can be supplied to the clothes either before, during, or after air is supplied to the clothes.

Moisture may be supplied to the clothes by generating steam and allowing the steam to pass into the accommodating space. Moisture may additionally or alternatively be supplied to the clothes by spraying a fine mist of liquid, such as water, into the accommodating space or by spraying a fine mist of water directly on the clothing.

If moisture is supplied to the clothes placed in the accommodating space, fine water particles (of the moisture) may be united with elements of unwanted odors in or on the fabric of the clothes. Then the water particles, united with the odor elements, may separate from the clothes during a drying process and be discharged to a space external to the accommodating space. In such a process the unwanted odors in or on the clothes may be reduced or removed.

Furthermore, if moisture is supplied to the clothes placed in the accommodating space of the clothes-treating apparatus, there may be an effect of reducing wrinkles in the clothes. Wrinkles, in the clothes having the moisture, may be reduced, or by extension, removed during the drying process, due to, for example, steam sprayed into the accommodating space to dry the clothes. In one embodiment, it may be effective to expose the clothes only to air or hot air when removing the unwanted odors, wrinkles, and/or humidity. In the same or different embodiment, moisture may also be supplied to the clothes to enhance the effect of the removal of the unwanted odors and wrinkles. The enhancement may be of a noticeable degree.

As a result, of the drying and odor reducing/eliminating process, a person wearing the clothes so treated can feel pleasant when putting on the clothes, even if the clothes have not been fully washed by a method, such as, complete immersion and agitation in water mixed with a detergent.

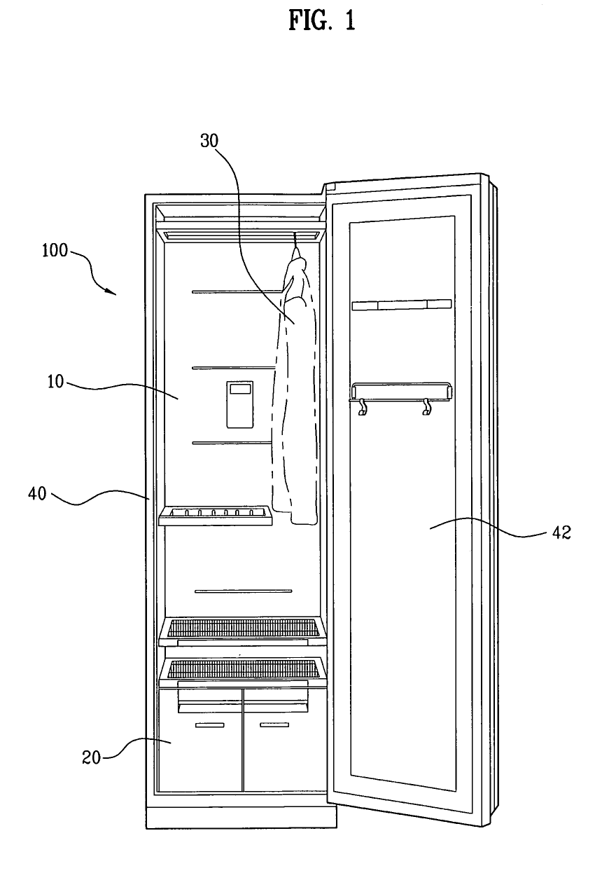

FIG. 1 illustrates that clothes 30 may be placed in an accommodating space 10 of a conventional clothes-treating apparatus 100. Typically, the clothes-treating apparatus is configured as a cabinet 40 having the accommodating space 10 for the clothes. The accommodating space 10 is provided in an upper portion of the cabinet 40 and a mechanism compartment 20 is provided under the accommodating space 10 in a lower portion of the cabinet 40. A moisture generation device (not shown) and an air supply device (not shown) may be provided in the mechanism compartment to supply moisture and dry air or dry hot air to the accommodating space 10, respectively.

The moisture generation device may be a kind of device to supply moisture to clothes, for example, a steam generator, or a water sprayer. In case of the water sprayer, a spray nozzle may be provided to spray water into the accommodating space. The water sprayer may be configured to provide fine water particle dispersion into the accommodating space 10. If a steam generator is used as the moisture generation device to supply steam to the clothes, an electric heater may be provided to heat water to generate steam.

Hot air may be supplied to the accommodating space 10 via a heating device. It is envisioned that the heating device may, for example, be a heat pump, an electric heater, a gas heater, or a combination thereof, that supplies hot air to the accommodating space 10.

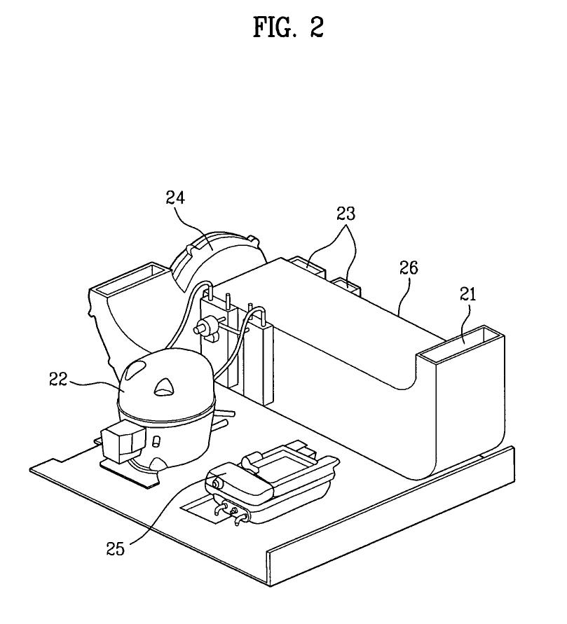

FIG. 2 illustrates the main elements inside a conventional mechanism compartment that supplies hot air to the clothes by using a heat pump. The steam generator 25, the heating device (e.g., a heat pump) comprising a compressor 22 and a heat exchanger 23, and a ventilation duct 24 may be provided in the mechanism compartment 20 of the clothes-treating apparatus 100. Air inside the accommodating space 10 is drawn in through the ventilation duct 24 to be heat-exchanged at the heat exchanger 23 and the heat-exchanged air is dehumidified or heated and supplied back to the accommodating space 10 through opening 21.

The heat exchanger 23 evaporates refrigerant that is supplied by the compressor 22 to dehumidify damp air inside the clothes-treating apparatus 100 and it condenses the refrigerant to re-heat the dehumidified air. It is necessary to compress the refrigerant between the evaporating and condensing steps applied to the refrigerant.

The compressing of the refrigerant may performed by the compressor 22 provided in the mechanism compartment 20 where the heat pump is mounted. The compressor repeats the refrigerant compressing process and as a result, operational conditions of the compressor might reach undesirable levels. The operational condition of the compressor may be an environmental variable including temperature or pressure, which are necessary in order for the compressor to operate normally. If the operational condition is not within predetermined limits, the reliability of compression may deteriorate, which typically will result in requiring increased power consumption to operate the compressor.

Thus, it is necessary to maintain a predetermined operational condition or property of the compressor such that the compressor may operate under a normal operational conditions without overload. The predetermined operational condition or property may be influenced by a temperature of the compressor 22, more specifically, a temperature or pressure of the compressed refrigerant. Compared with a temperature and pressure of the refrigerant supplied to the compressor, the temperature and pressure of the compressed refrigerant is another aspect and may be indicative of different operational properties. If a single property or variable is extracted, the other variable may be determined accordingly.

One of the most prevalent reasons why the compressor 22 may be exposed to an overload is that the temperature or pressure of the compressed refrigerant is substantially high. If the evaporated refrigerant from the heat exchanger 23 is drawn into the compressor 22, the temperature and pressure of the refrigerant might happen to be over a normal operational condition of the compressor.

In addition, in the mechanism compartment where the compressor 22 is located, a steam generator may be provided as the moisture generation device. Here, the steam generator 25 heats water to generate steam. As a result, external surfaces of the steam generator 25 may have high temperature due to the heated water therein, thus emitting heat within the mechanism compartment 20. The steam generator 25 may be employed as a heating element inside the mechanism compartment 20 where the compressor 22 is installed.

Furthermore, air inside the accommodating space 10 may be drawn in and dehumidified or heated in a circulation duct 26. The dehumidified or heated air is then re-supplied to the accommodating space 10 through the circulation duct 26 and opening 21. As a result, the inside of the mechanism compartment may also be heated because of the heated air flowing through the circulation duct 26.

Additionally, the temperature of a portion of the heat exchanger 23 where the air flowing in the circulation duct 26 is heated by condensing the refrigerant is relatively high. If this temperature rises, the temperature of the mechanism compartment also may rise accordingly, such that the compressor 22 may be heated indirectly.

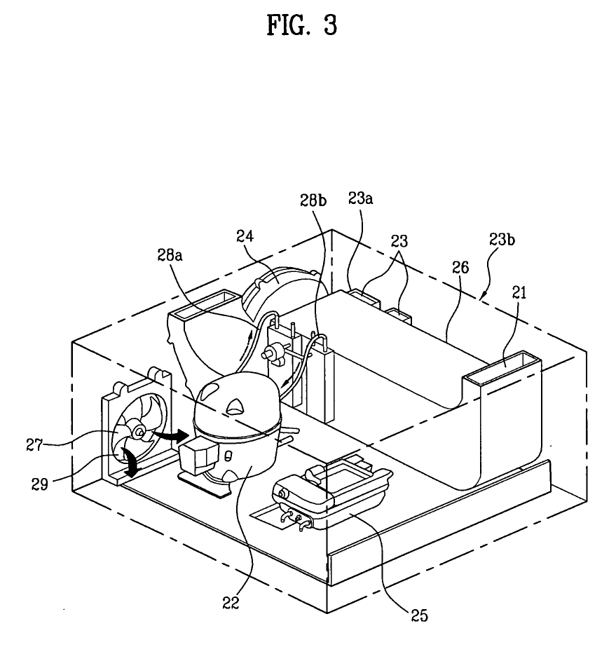

FIG. 3 illustrates the compressor 22 and a cooling fan 27 provided in the mechanism compartment 20 according to an embodiment of the invention. The cooling fan 27, shown in FIG. 3, cools the inside of the mechanism compartment where the compressor 22 is installed. A ventilation opening 29 may be formed at the cabinet 40 that forms an exterior appearance of the mechanism compartment 20 and the cooling fan 27 may be installed at the ventilation opening 29.

It is noted that when the cooling fan 27 is operated to cool the mechanism compartment 20 where the compressor 22 is installed, noise may occur and external dust may be drawn into the mechanism compartment 20. Thus, it may be desirable to reduce the operation of the cooling fan 27 as much as possible. A method of reducing the operation of the cooling fan 27 may be that the cooling fan 27 is operated selectively depending on the internal environment of the mechanism compartment 20, thus satisfying the normal operational conditions of the compressor 22. That is, the cooling fan 27 may be selectively operated only if the predetermined operational condition of the compressor 22 included in the heat pump is out of the normal condition.

To operate the cooling fan 27 selectively, it is necessary to determine the predetermined operational condition of the compressor 22. Thus, a controlling method of the clothes-treating apparatus according to an exemplary embodiment may include steps of operating the heat pump, measuring the predetermined operational condition of the compressor 22 included in the heat pump, and controlling the cooling fan 27 provided in the mechanism compartment 20.

As mentioned above, the clothes-treating apparatus includes the accommodating space 10 and the mechanism compartment 20, partitioned from the accommodating space in the cabinet, where the air supply device including the heat pump and the circulation duct 26 and the moisture generation device supplying moisture to the accommodating space 10 are installed, in order to supply dry air or dry heated air to the accommodating space 10.

As mentioned above, the normal operational condition of the compressor 22 may be defined by an operational pressure of the compressor 22. The operational pressure may be determined by an intake temperature, i.e. the temperature of the refrigerant drawn into the compressor. The intake temperature of the refrigerant may be measured by a temperature sensor 32 provided adjacent to the compressor 22. While determining the operational pressure of the compressor is disclosed, it is envisioned that the normal operating conditions of the compressor may be defined by various other properties of a compressor and/or the environment in which it is placed.

It is possible to indirectly measure the temperature of the refrigerant entering the compressor 22, if the temperature sensor 32 is installed at a location near the compressor 22 where the refrigerant enters the compressor 22.

A reliable indicator of the predetermined operational condition of the compressor 22 is the pressure of the entering refrigerant, which relates to the compression efficiency. However, it is not easy to install a pressure sensor in a pipe or the compressor 22 in order to measure the pressure of entering refrigerant, but it is simple to measure the temperature of the entering refrigerant. It is also not easy to install the temperature sensor in the compressor 22 or a refrigerant pipe that connects the compressor 22 with the heat exchanger 23 directly. Thus, the temperature sensor may be installed outside of the refrigerant pipe.

As shown in FIG. 3, a refrigerant intake pipe 28b is provided to transport refrigerant returning to the compressor 22 after dehumidifying the circulated air by evaporation. If the temperature sensor 32 is installed outside the refrigerant intake pipe 28b, it is possible to indirectly measure the temperature and pressure of the refrigerant entering the compressor 22. It is also possible to install the temperature sensor near the compressor 22, specifically, at a surface of the compressor 22 or in the mechanism compartment 20. However, the preferable position of the temperature sensor is a surface of the refrigerant intake pipe 28b, through which the refrigerant evaporated at the heat exchanger 23 flows into the compressor.

The temperature of the air that passes a condensation portion of the heat exchanger 23, that heats the circulated air by the condensation of the refrigerant, may be high compared with the temperature of the air drawn into the circulation duct. As a result, an alternate temperature sensor (not shown) may be installed in the circulation duct 26, which surrounds the condensation portion 23b. More specifically, it may be installed between an end portion of the circulation duct 26, between the condensation portion 23a and the ventilation duct 24 to measure the temperature of the mechanism compartment 20, such that the predetermined operational condition of the compressor 22 may be determined indirectly.

The controlling method of the clothes-treating apparatus may further include supplying moisture to the accommodating space 10 prior to the step of measuring the predetermined operational condition of the compressor 22 included in the heat pump. Here, the supplying of the moisture means that moisture is supplied to the accommodating space 10. As mentioned above, if the steam generator 25 as the moisture generation device shown in FIG. 3 supplies steam to the accommodating space 10, the temperature of the mechanism compartment 20 may be influenced by the temperature of the steam generator 25. Accordingly, the predetermined operational condition of the compressor 22 may be also affected according to before or after the supplying of the moisture, that is, steam.

According to an embodiment of a controlling method of the clothes-treating apparatus, the cooling fan 29 may be operated before the heat pump is put into operation. As mentioned above, the moisture or steam might be supplied to the accommodating space 10 before initiating operation of the heat pump. In this case, the mechanism compartment 20 may be heated by the steam generator 25 such that it exceeds the normal operational condition of the compressor 22. Thus, the cooling fan 29 may be operated prior to the operation of the heat pump.

Once the determination of the predetermined operational condition of the compressor is accomplished as mentioned above, the cooling fan may be controlled. For example, if the temperature measured by the temperature sensor (hereinafter, ‘the intake temperature of the refrigerant’) is over a predetermined temperature, the cooling fan may be controlled. If the cooling fan 29 is stopped, the cooling fan 29 may be controlled such that it is put into operation. If it is operated at a relatively low speed of rotation, the cooling fan 29 may then be adjusted to be operated at a relatively high speed of rotation.

The control of the cooling fan 29 and measurement of the predetermined operational condition may be repeated until the temperature measured by the temperature sensor 32 is in a range of the normal operational condition. In one embodiment, the measurement of the predetermined operational condition of the compressor 22 and the control of the cooling fan 29 may be repeated periodically according to a predetermined time period, if the heat pump is put into operation. Alternatively, the temperature measured by the temperature sensor 32 may be continuously compared to a predetermined temperature and the cooling fan can be operated when the temperature measured by the temperature sensor 32 exceeds the predetermined temperature.

According to one embodiment of the controlling method of the clothes-treating apparatus, if the moisture generation device supplies moisture (e.g., in the form of steam comprised of a fine mist) to the accommodating space 10, the cooling fan may be controlled to operate. If the predetermined operational condition, e.g. the temperature of the mechanism compartment 20 or temperature of the refrigerant entering the compressor 22 through refrigerant input pipe 28b, is within the range of the normal operational condition, the cooling fan 29 does not have to be put into operation. As a result, the step of measuring the predetermined operational condition of the heat pump and the step of controlling the cooling fan 29 are independently performed between the step of the supplying of the steam and the step of the operation of the heat pump.

In addition, the temperature sensor may be provided in plural as means for determining the predetermined operational condition of the compressor. If there are plural temperature sensors (not shown), an average value or a maximum value of the measured temperatures may be used. The temperature measured by the temperature sensor(s) is then compared with a predetermined temperature, as before.

If a difference between a measured temperature and the predetermined temperature is detected, there may be an operational signal for controlling the cooling fan 29. The operational signal may be constructed to vary the rotational speed of the fan, such that, for example, as the difference between the measured value and the predetermined value increases, the rotational speed of the cooling fan 29 may be controlled to increase as well. The rotational speed of the cooling fan 29 may be proportional to the difference between the measured value and the predetermined value.

In general, if a compressor is over-heated, the operation of the compressor may be stopped to lower the temperature thereof. However, it is more efficient to cool the compressor 22 by the operation of the cooling fan 29.

On the other hand, according to another method of determining the predetermined operational condition of the compressor 22 according to an embodiment of the invention, the consumed power of the compressor may be measured and compared to a predetermined value. If the consumed power of the compressor 22 is higher than the predetermined value, the compression efficiency of the refrigerant may deteriorate proportionally. The method of measuring the consumed power of the compressor 22 may be accomplished by measuring a voltage and electric current applied to the compressor 22.

If the temperature of the compressor 22 that compresses the refrigerant evaporated at the heat exchanger 23 is increasing, it takes more energy to compress the refrigerant. As a result, the power consumed at the compressor 22 may be measured and if a value of the measured power is higher than a predetermined value, the cooling fan 29 may be operated to cool the compressor 22. If the measured value is higher than the predetermined value, it is preferable that the rotational speed of the cooling fan 27 is determined in proportion to the difference between the measured value and the predetermined value.

The method of lowering the temperature of the compressor 22 may be identical to that used when the method of determining the predetermined operational condition of the compressor 22 made use of a temperature sensor. Using the measured temperatures or power consumed, the cooling fan 29 may be operated, or the operation of the compressor 22 may be stopped.

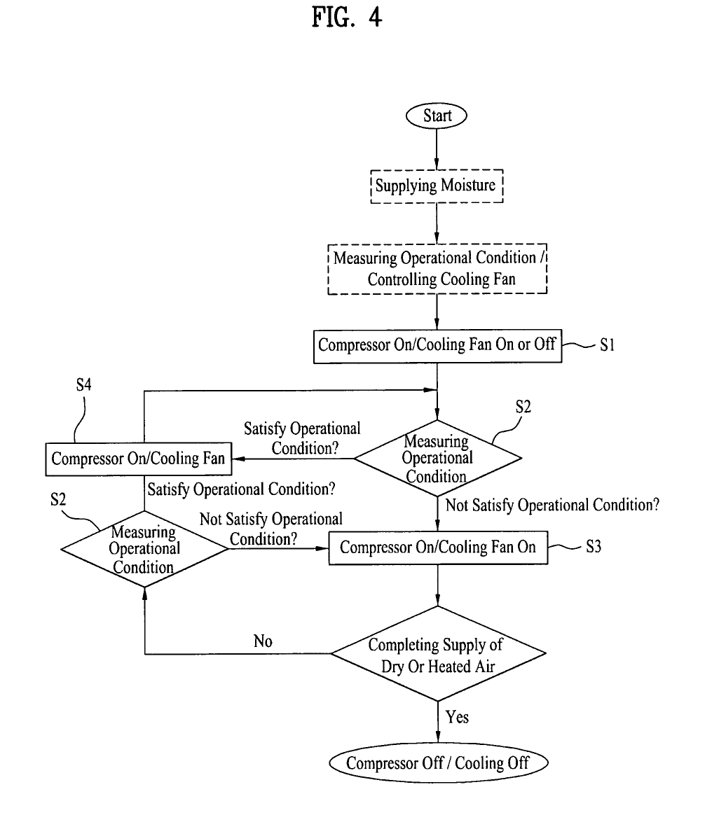

FIG. 4 is a block diagram of a controlling method of a clothes-treating apparatus according to an exemplary embodiment of the invention. As shown in FIG. 4, the heat pump provided in the mechanism compartment may be put into operation to supply hot air to clothes placed in the accommodating space.

‘S1’ indicates a step in which the heat pump, including the compressor, dehumidifies or heats air to supply the dehumidified or heated air to the accommodating space. At this time, the cooling fan 29 may be being operated (i.e., ON) or not operated (i.e., OFF). ‘S2’ indicates a step of determining the predetermined operational condition of the compressor. A measurement variable in S2 may be a temperature measured by the temperature sensor 32 or the consumed power of the compressor. Any variable that is capable of determining the predetermined operational condition of the compressor included in the heat pump may be used rather than either of the above two variables. For example, an inner temperature of the mechanism compartment may be used.

The predetermined temperature or the predetermined consumed power that may be compared with the measured variables to determine whether the compressor is overheated may be determined according to predetermined conditions, respectively. The variables may be determined, for example, based on the type of the compressor, an inner structure of the mechanism compartment, or a temperature of the hot air supplied to the accommodating space.

‘S3’ indicates a step in that the cooling fan 29 is put into operation while the compressor 22 is being operated. If the measured variable of step S2 is larger than the predetermined temperature, or alternatively larger than the predetermined value of consumed power, the cooling fan 29 may be turned on. If the normal operational condition is satisfied while the compressor 22 is being operated, the cooling fan may not be put into operation. Thus, the state of only the compressor being operated (S4) is maintained.

At this time, the step of S2, i.e. measuring the predetermined operational condition, may be repeated periodically, or continuously, during the operation of the compressor. If it is determined that a measured variable is over the predetermined value of the temperature or consumed power during the operation of only the compressor, the cooling fan may be operated again.

In the case where moisture, in the form of steam, is supplied to the accommodating space, S3 or S2 and S3 may be repeated prior to the step of operating the heat pump as mentioned above. Once the dry or heated air has stopped being supplied to the accommodating space, the operation of the compressor and the cooling fan may also be stopped.

FIG. 5 illustrates a clothes-treating apparatus 500 according to an embodiment of the invention. The clothes-treating apparatus 500 according to an embodiment of the invention may include: a cabinet 50 having an accommodating space for clothes, an air supply device having a heat pump configured as a compressor 22 and a heat exchanger 23 to supply dry or dry heated air to the accommodating space, a temperature sensor 32 installed on either a pipe 28b connecting the heat exchanger 23 and the compressor 22 or a rear end of the heat exchanger 23, a cooling fan 29 mounted in a mechanism compartment 20 provided in a lower portion of the cabinet 50, and a controller 52, which controls the cooling fan 29 based at least on a temperature measured at the temperature sensor 32. Here, clothes being treated are placed in the accommodation space. The above air supply device is provided in the mechanism compartment 20. The controller 52 is also employed to control any controllable elements, including the cooling fan 29, and the compressor 22.

The temperature 32 sensor installed at the refrigerant intake pipe, which fluidly connects the heat exchanger 23 and the compressor 22. The temperature sensor may be installed at a surface of the refrigerant intake pipe 28a though which the refrigerant evaporated at the heat exchanger 23 flows. Alternatively, the temperature sensor installed at the rear end of the heat exchanger 23 may be installed at a predetermined portion of the rear end where the temperature of the air having passed through the heat exchanger 23 can be measured.

A moisture generation device may be further included in the clothes-treating apparatus to supply moisture to the accommodating space. The moisture may be admitted to the accommodating space 10 by a nozzle 54. The nozzle 54 may be in fluid communication with, for example, steam generator 25, which generates steam as mentioned above. Alternatively, the moisture generation device may be a configured to provide a fine water particulate dispersion to the accommodating space. The moisture generation device, e.g., steam generator 25, may also be controlled by the controller 52.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1-23. (canceled)

24. A controlling method for a clothes treating apparatus comprising an air supply device including a heating device and a circulation duct that are provided in a mechanism compartment to supply dry heated air to an accommodating space within a cabinet, the mechanism compartment being partitioned from the accommodating space, and a moisture generation device, which supplies moisture to the accommodating space, the controlling method comprising:
supplying moisture from the moisture generation device into the accommodating space; operating the heating device;
determining the value of a parameter associated with the current operational condition of the heating device; and
controlling a cooling fan provided in the mechanism compartment based on the parameter value.

25. The controlling method as claimed in claim 24, wherein the heating device comprises a heat pump, the heat pump including a heat exchanger and a compressor.

26. The controlling method as claimed in claim 25, wherein controlling the cooling fan further comprises comparing the parameter value to a predetermined value that relates to the operational condition of the compressor.

27. The controlling method as claimed in claim 26, wherein the parameter value and the predetermined value relate to the temperature of refrigerant flowing into the compressor.

28. The controlling method as claimed in claim 27, wherein the temperature of the refrigerant is measured by a temperature sensor provided adjacent to the compressor.

29. The controlling method as claimed in claim 28, wherein if the temperature of the refrigerant is above a predetermined temperature, the cooling fan is put into operation.

30. The controlling method as claimed in claim 28, wherein the temperature sensor is provided in a circulation duct provided in the mechanism compartment to circulate the air inside the accommodating space.

31. The controlling method as claimed in claim 30, wherein the temperature sensor is provided in a rear portion of the circulation duct.

32. The controlling method as claimed in claim 28, wherein a plurality of temperature sensors are employed to measure the temperature of the refrigerant, and controlling the cooling fan is based on an average value or a maximum value of temperature values measured at the plural temperature sensors.

33. The controlling method as claimed in claim 27, wherein the temperature of the refrigerant is measured by a temperature sensor provided at a refrigerant pipe connecting the compressor and the heat exchanger.

34. The controlling method as claimed in claim 33, wherein the temperature sensor is provided at a surface of a refrigerant pipe through which the refrigerant flows into the compressor.

35. The controlling method as claimed in claim 26, wherein the parameter value and the predetermined value relate to the pressure of refrigerant flowing into the compressor.

36. The controlling method as claimed in claim 25, further comprising: supplying moisture to the accommodating space prior to the determining the parameter value associated with the condition of the heat device.

37. The controlling method as claimed in claim 36, wherein the moisture generation device is a steam generator.

38. The controlling method as claimed in claim 37, wherein the cooling fan is operated after supplying steam and during the operating of the heat pump.

39. The controlling method as claimed in claim 25, wherein the cooling fan operates before the heat pump starts to operate.

40. The controlling method as claimed in claim 26, wherein measuring the parameter value and controlling cooling fan are repeated during the operation of the heat pump.

41. The controlling method as claimed in claim 40, wherein measuring the parameter value is performed periodically.

42. The controlling method as claimed in claim 26, wherein the parameter value and the predetermined value relate to power consumed by the compressor.

43. The controlling method as claimed in claim 42, wherein the cooling fan is operational if the consumed power of the compressor is above a predetermined value.

44. A clothes treating apparatus comprising:
a cabinet comprising an accommodating space where clothes are placed;
an air supply device comprising a heat pump, the heat pump including a compressor and a heat exchanger, to supply dry or heated dry air to the accommodating space;
a temperature sensor installed on at least one of a pipe connecting the heat exchanger and the compressor or the heat exchanger;
a cooling fan mounted in a mechanism compartment, the mechanism compartment provided in a lower portion of the cabinet, wherein the air supply device is provided in the mechanism compartment; and
a control part which controls the cooling fan based on a temperature value measured by the temperature sensor.

45. The clothes treating apparatus as claimed in claim 44, wherein the temperature sensor is installed on the pipe between the compressor and the heat exchanger, at a point on the pipe where the refrigerant flow through the pipe is evaporated, and wherein the temperature sensor is adapted to measure the surface temperature of the pipe.

46. The clothes treating apparatus as claimed in claim 44, wherein the temperature sensor is installed at the heat exchanger and is adapted to measure the temperature of the air around the heat exchanger.

47. The clothes treating apparatus as claimed in claim 44, further comprising a moisture generation device which supplies moisture to the accommodating space.

48. The clothes treating apparatus as claimed in claim 47, wherein the moisture generation device is a steam generator.
